(19) United States
(12) Patent Application Publication
(10) Pub. No.: US 2020/0112042 A1
(43) Pub. Date: Apr. 9, 2020

(54) ASSEMBLY APPARATUS AND MANUFACTURING METHOD FOR MEMBRANE-ELECTRODE-GAS DIFFUSION LAYER-ASSEMBLY

(71) Applicant: TOYOTA JIDOSHA KABUSHIKI KAISHA, Toyota-shi (JP)

(72) Inventor: Hirohiko HISANO, Toyota-shi (JP)

(21) Appl. No.: 16/575,647

(22) Filed: Sep. 19, 2019

(30) Foreign Application Priority Data
Oct. 5, 2018 (JP) 2018-189634

(51) Int. Cl. H01M 8/1004; B29C 63/02; B32B 37/00; H01M 8/02; H01M 4/86; H01M 4/88

(52) U.S. Cl. CPC H01M 8/1004; B29C 63/02; B32B 37/0053; H01M 8/02; B32B 2457/18; H01M 4/881; H01M 4/8896; H01M 4/8807; H01M 4/8657

(57) ABSTRACT

An assembly apparatus for a membrane-electrode-gas diffusion layer-assembly for a cell for fuel cell capable of positioning and assembling materials while suppressing failures is provided. An assembly apparatus includes a pair of transfer rollers, a first detection unit, a second detection unit, and a conveyance unit. The conveyance unit includes a pair of first rollers and a pair of second rollers. The pair of first rollers are arranged to be separated in a width direction of a band-shaped sheet intersecting with a conveying direction, and rotate in contact with the preliminary assembly. The pair of second rollers are arranged to be separated in the width direction, and rotate while sandwiching the preliminary assembly with the pair of first rollers. An inclination at least one of the first roller or the second roller varies with respect to the conveying direction together with the preliminary assembly.

### CROSS REFERENCE TO RELATED APPLICATIONS

The present application claims priority from Japanese patent application JP 2018-189634 filed on Oct. 5, 2018, the content of which is hereby incorporated by reference into this application.

### BACKGROUND

### Technical Field

The present disclosure relates to an assembly apparatus and a method for manufacturing a Membrane-Electrode-Gas diffusion layer-assembly (MEGA) used for a cell for fuel cell.

### Background Art

JP 2017-091700 A discloses a carrying apparatus for battery material that adjusts a position and/or a posture in a planar direction of a workpiece relating to a battery material in a process of carrying the workpiece in a predetermined direction. The carrying apparatus for battery material disclosed in JP 2017-091700 A includes a first carrying unit, a second carrying unit, and an alignment unit (see claim 1 and the like in JP 2017-091700 A).

The first carrying unit carries the workpiece in the predetermined direction. The second carrying unit is disposed on a forward side in the carrying direction of the first carrying unit and carries the workpiece in the predetermined direction. The alignment unit is disposed between the first carrying unit and the second carrying unit. The alignment unit includes a rotating roller that rotates in the carrying direction at a predetermined rotation speed. The action of the rotating roller moves and/or rotates the workpiece carried from the first carrying unit in the planar direction while carrying the workpiece toward the second carrying unit.

With this configuration, the action of the rotating roller ensures moving and/or rotating the workpiece carried from the first carrying unit in the planar direction while carrying the workpiece to the second carrying unit. Therefore, a position and/or a posture in the planar direction of the workpiece can be easily and surely adjusted in the process of carrying the workpiece in the predetermined direction (see Paragraph 0010 and the like in JP 2017-091700 A).

### SUMMARY

The conventional carrying apparatus for battery material disclosed in JP 2017-091700 A is used for, for example, carrying the workpiece relating to the battery material of a positive electrode plate, a separator, and a negative electrode plate for constituting a laminated battery (see Paragraphs 0002 to 0008 and the like in JP 2017-091700 A). However, a material such as an electrolyte membrane for constituting a membrane-electrode-gas diffusion layer-assembly for a fuel cell is extremely thin compared with the materials constituting the laminated battery.

In the case of carrying such an ultra-thin material by the above-described conventional carrying apparatus, it is difficult to move and/or rotate the ultra-thin material in the planar direction with only the rotating roller of the alignment unit disposed on the lower side. Therefore, it is considered to use an alignment unit that includes an upper rotating roller and a lower rotating roller, which are mutually opposed in a height direction intersecting with the carrying direction of the ultra-thin material (see Paragraph 0052 and the like in JP 2017-091700 A).

In this case, the ultra-thin material is sandwiched between the upper rotating roller and the lower rotating roller, and a phase difference is generated between the rotation speeds of the upper and lower rotating rollers disposed on both sides in a direction intersecting with the carrying direction and the height direction of the ultra-thin material, thus moving and/or rotating the ultra-thin material in the planar direction. However, since the rotation direction of each rotating roller is parallel to the conveying direction, the ultra-thin material possibly gets twisted to cause a failure such as separation on the assembly.

The present disclosure provides an assembly apparatus and a manufacturing method for a membrane-electrode-gas diffusion layer-assembly for a cell for fuel cell capable of positioning and assembling materials while suppressing a failure caused in the above-described conventional carrying apparatus.

An aspect of this disclosure is an assembly apparatus that assembles a first catalyst layer and a preliminary assembly for constituting an electrolyte membrane-electrode-gas diffusion layer-assembly. The assembly apparatus includes a pair of transfer rollers, a first detection unit, a second detection unit, and a conveyance unit. The pair of transfer rollers transfer the first catalyst layer from a band-shaped sheet to the preliminary assembly while conveying the band-shaped sheet, a plurality of the first catalyst layers are formed on the band-shaped sheet. The first detection unit detects an inclination of the first catalyst layer with respect to a conveying direction of the band-shaped sheet. The second detection unit detects an inclination of the preliminary assembly with respect to the conveying direction. The conveyance unit is disposed to be capable of adjusting the inclination of the preliminary assembly such that the inclination of the preliminary assembly matches the inclination of the first catalyst layer. The conveyance unit inserts the preliminary assembly between the pair of transfer rollers. The conveyance unit includes a pair of first rollers and a pair of second rollers. The pair of first rollers are arranged to be separated in a width direction of the band-shaped sheet. The width direction intersects with the conveying direction. The pair of first rollers rotate in contact with the preliminary assembly. The pair of second rollers are arranged to be separated in the width direction. The pair of second rollers rotate while the pair of second rollers sandwiches the preliminary assembly with the pair of first rollers. An inclination of at least one of the first roller or the second roller with respect to the conveying direction varies together with the preliminary assembly.

The cell for fuel cell includes, for example, a pair of separators, a pair of frame-shaped resin frames disposed between the pair of separators, and an electrolyte membrane-electrode-gas diffusion layer-assembly (hereinafter, referred to as “MEGA” for short) disposed between the pair of resin frames. The MEGA has a configuration where, for example, a gas diffusion layer, a first catalyst layer, an electrolyte membrane, a second catalyst layer, and a gas diffusion layer are laminated in this order and assembled, and the catalyst layers are disposed at openings of the resin frames. The cell for fuel cell performs electric generation such that an oxidizing gas containing oxygen and a gas containing hydrogen are flown through the gas flow channels between the pair of separators and the MEGA, and these gases are reacted via the MEGA.

The assembly apparatus according to the one aspect is an apparatus, for example, that preliminarily laminates and assembles the electrolyte membrane, the second catalyst layer, and the gas diffusion layer constituting the MEGA and laminates and assembles the first catalyst layer on the preliminary assembly cut in a predetermined shape. The preliminary assembly and the first catalyst layer are formed in, for example, rectangular shapes.

The band-shaped sheet is a sheet that supports and conveys the first catalyst layer to laminate the first catalyst layer on the preliminary assembly. The band-shaped sheet is wound up and collected by, for example, a collection roller after the first catalyst layer is transferred to the preliminary assembly.

The plurality of first catalyst layers are formed in the conveying direction as the longitudinal direction of the band-shaped sheet at predetermined intervals by, for example, intermittently applying a slurry material of the first catalyst layer over one surface of the band-shaped sheet. The first catalyst layer formed on the band-shaped sheet slightly has the inclinations with respect to the conveying direction of the band-shaped sheet, variations in shape, displacements in position in the conveying direction and the width direction of the band-shaped sheet, or the like.

The pair of transfer rollers are disposed, for example, to be adjacent in the up-down direction so as to have the rotation axes approximately horizontal. The pair of transfer rollers are configured to rotate in mutually opposite directions, and sandwich the band-shaped sheet to convey. The pair of transfer rollers sandwich the preliminary assembly inserted therebetween by the conveyance unit with the band-shaped sheet, and transfer the first catalyst layer formed on the band-shaped sheet to the electrolyte membrane of the preliminary assembly by applying pressure and assembling. In the one aspect, the conveying direction of the band-shaped sheet is, for example, a tangential direction of a lower end of one transfer roller disposed on the upper side and an upper end of the other transfer roller disposed on the lower side.

The first detection unit detects the inclination of the first catalyst layer with respect to the conveying direction of the band-shaped sheet. In the assembly apparatus according to the one aspect, for example, the first detection unit is an imaging device that takes an image of the individual first catalyst layer formed on the band-shaped sheet. For example, the first detection unit obtains image data of the individual first catalyst layer, and detects an outer peripheral edge of the individual first catalyst layer based on the obtained image data to detect four sides of the individual first catalyst layer having the rectangular outer shape. The first detection unit detects a longitudinal center line along the conveying direction of the band-shaped sheet and a lateral center line along the width direction of the band-shaped sheet of the individual first catalyst layer based on the detection result of the outer peripheral edge of the individual first catalyst layer.

Furthermore, the first detection unit detects the inclination of the individual first catalyst layer with respect to the conveying direction of the band-shaped sheet based on, for example, the detection result of the above-described center lines. The first detection unit detects the position of the center point of the first catalyst layer, which is an intersection point of the center lines, as the position of the individual first catalyst layer based on, for example, the detection results of the above-described longitudinal and lateral center lines. The first detection unit detects, for example, the position of the first catalyst layer in the width direction of the band-shaped sheet. In the assembly apparatus according to the one aspect, the first detection unit is not limited to the imaging device but only needs to detect the inclination and the position of the first catalyst layer. The first detection unit may be, for example, a laser-type displacement sensor.

The second detection unit detects the inclination of the preliminary assembly with respect to the conveying direction of the band-shaped sheet. In the assembly apparatus according to the one aspect, for example, the second detection unit is an imaging device that takes an image of the preliminary assembly located on the conveyance unit. For example, the second detection unit obtains image data of the individual preliminary assembly, and detects an outer peripheral edge of the individual preliminary assembly based on the obtained image data to detect four sides of the individual preliminary assembly having the rectangular outer shape. The second detection unit detects a longitudinal center line along the conveying direction of the band-shaped sheet and a lateral center line along the width direction of the band-shaped sheet of the preliminary assembly located on the conveyance unit based on the detection result of the outer peripheral edge of the preliminary assembly located on the conveyance unit.

Furthermore, for example, the second detection unit detects the inclinations of the preliminary assembly with respect to the conveying direction of the band-shaped sheet based on the detection results of the above-described center lines. For example, the second detection unit detects a position of the center point of the preliminary assembly, which is an intersection point of the center lines, as a position of the preliminary assembly located on the conveyance unit based on the detection results of the above-described longitudinal and lateral center lines. For example, the second detection unit detects the position of the preliminary assembly in the width direction of the band-shaped sheet. The second detection unit is not limited to the imaging device but only needs to detect the inclination and the position of the preliminary assembly. The second detection unit may be, for example, a laser-type displacement sensor.

The conveyance unit is disposed to be capable of adjusting the inclination of the preliminary assembly such that the inclination of the preliminary assembly matches the inclination of the first catalyst layer, and configured to insert the preliminary assembly between the pair of transfer rollers. More specifically, the conveyance unit includes the pair of first rollers and the pair of second rollers. The pair of first rollers are arranged to be separated in the width direction of the band-shaped sheet intersecting with the conveying direction of the band-shaped sheet, and rotate in contact with the preliminary assembly. The pair of second rollers are arranged to be separated in the width direction of the band-shaped sheet, and rotate while sandwiching the preliminary assembly with the pair of first rollers.

The conveyance unit drives to rotate at least one of the first rollers or the second rollers with a drive unit such as a motor. Thus, the conveyance unit can convey the preliminary assembly sandwiched between the pair of first rollers and the pair of second rollers in the conveying direction of the band-shaped sheet, and insert the preliminary assembly between the pair of transfer rollers.

Furthermore, at least one of the first rollers or the second rollers is configured to vary its inclination with respect to the conveying direction together with the preliminary assembly. With this configuration, when the conveyance unit rotates the preliminary assembly to adjust the inclination such that the inclination of the preliminary assembly matches the inclination of the first catalyst layer, at least one of the first rollers or the second rollers turn with the preliminary assembly to vary the inclination with respect to the conveying direction.

Thus, the occurrence of twist on the preliminary assembly including the ultra thin electrolyte membrane is avoided, and the occurrence of the failure such as separation on the preliminary assembly can be suppressed. Matching the inclination of the preliminary assembly with the inclination of the first catalyst layer ensures assembling the first catalyst layer with the preliminary assembly in the state where the positional displacement between the first catalyst layer and the preliminary assembly is reduced even when the first catalyst layer has the inclination with respect to the conveying direction of the band-shaped sheet. Accordingly, the first catalyst layer and the second catalyst layer of the MEGA can be surely disposed at the opening of the resin sheet, thus ensuring the improved power generation efficiency of the cell for fuel cell.

In the assembly apparatus according to the one aspect, the conveyance unit may include, for example, the adjustment table on which the preliminary assembly is placed. The first rollers and the second rollers may be disposed on the adjustment table. The adjustment table may include a rotating unit that adjusts the inclination with respect to the conveying direction to match the inclination of the preliminary assembly with the inclination of the first catalyst layer.

With this configuration, the preliminary assembly is placed on the adjustment table, and the adjustment table is rotated by the rotating unit, thus adjusting the inclination of the adjustment table with respect to the conveying direction of the band-shaped sheet. Accordingly, the inclination of the preliminary assembly can be matched with the inclination of the first catalyst layer. Furthermore, the adjustment table includes the first rollers and the second rollers. Therefore, rotating the adjustment table on which the preliminary assembly is placed to adjust the inclination of the preliminary assembly with respect to the conveying direction of the band-shaped sheet varies the inclinations of the first rollers and the second rollers with respect to the conveying direction of the band-shaped sheet with the preliminary assembly. This avoids occurrence of twist on the preliminary assembly including the ultra thin electrolyte membrane, and the occurrence of the failure such as separation on the preliminary assembly can be suppressed.

The assembly apparatus according to the one aspect may be configured such that, for example, the first detection unit detects a position of the first catalyst layer in the width direction of the band-shaped sheet, the second detection unit detects a position of the preliminary assembly in the width direction, the adjustment table includes a drive unit capable of adjusting a position in the width direction, and the drive unit adjusts the position of the adjustment table to match the position of the preliminary assembly with the position of the first catalyst layer.

With this configuration, the adjustment table on which the preliminary assembly is placed is moved by the drive unit in the width direction of the band-shaped sheet and the position of the adjustment table is adjusted, thus ensuring the adjustment of the position of the preliminary assembly. Therefore, even when the first catalyst layer formed on the band-shaped sheet has the displacement in position in the width direction of the band-shaped sheet, the position of the preliminary assembly can be matched with the position of the first catalyst layer. This ensures assembling the first catalyst layer with the preliminary assembly in the state where the positional displacement between the first catalyst layer and the preliminary assembly is reduced. Accordingly, the first catalyst layer and the second catalyst layer of the MEGA can be surely disposed at the opening of the resin sheet, thus ensuring the improved power generation efficiency of the cell for fuel cell.

The assembly apparatus according to the one aspect may be configured such that the first detection unit detects a center line along the conveying direction and a center line along the width direction of the first catalyst layer to detect the inclination and the position of the first catalyst layer, and wherein the second detection unit detects a center line along the conveying direction and a center line along the width direction of the preliminary assembly to detect the inclination and the position of the preliminary assembly.

With this configuration, for example, even when the first catalyst layer formed on the band-shaped sheet has the variation in shape, the positions of the preliminary assembly and the first catalyst layer can be matched by matching the positions of the first catalyst layer and the preliminary assembly to minimize the difference between the inclinations of the longitudinal and lateral center lines. This ensures assembling the first catalyst layer with the preliminary assembly in the state where the positional displacement between the first catalyst layer and the preliminary assembly is reduced. Accordingly, the first catalyst layer and the second catalyst layer of the MEGA can be surely disposed at the opening of the resin sheet, thus ensuring the improved power generation efficiency of the cell for fuel cell.

In the assembly apparatus according to the one aspect, the first detection unit and the second detection unit are, for example, the imaging devices. With this configuration, as described above, the center lines along the conveying direction of the band-shaped sheet and the center lines along the width direction of the band-shaped sheet of the first catalyst layer and the preliminary assembly can be easily detected.

In the assembly apparatus according to the one aspect, the preliminary assembly is an assembly of, for example, an electrolyte membrane, a second catalyst layer, and a gas diffusion layer. For example, such a preliminary assembly is manufactured as follows. First, for example, a slurry material of the second catalyst layer is intermittently applied over the ultra thin band-shaped electrolyte membrane supported by the band-shaped back sheet, thus forming a plurality of second catalyst layers in the conveying direction as the longitudinal direction of the back sheet at the predetermined intervals.

Next, the band-shaped gas diffusion layer is inserted between the pair of transfer rollers with the band-shaped electrolyte membrane, on which the second catalyst layer CL2 is formed, supported by the band-shaped back sheet. Thus, the band-shaped gas diffusion layer is laminated on and assembled with the band-shaped electrolyte membrane on which the plurality of second catalyst layers are formed. Subsequently, the electrolyte membrane is separated from the back sheet, and the back sheet is wound up by the collection roller to be collected. Furthermore, the band-shaped preliminary assembly where the band-shaped gas diffusion layer, the plurality of second catalyst layers, and the band-shaped electrolyte membrane are assembled is cut between the individual second catalyst layers, thus ensuring the manufacture of the rectangular preliminary assembly body.

Thus, preliminarily assembling the electrolyte membrane, the second catalyst layer, and the gas diffusion layer before cutting ensures the improved yield of the MEGA. More specifically, for example, the band-shaped electrolyte membrane possibly has a part with the defect. A part of the plurality of second catalyst layers possibly has the defect. Similarly, the band-shaped gas diffusion layer possibly has a part with the defect. Furthermore, the band-shaped preliminary assembly where these components are assembled possibly has a part where the poor assembly occurs.

Therefore, selectively disposing the part with the defect and the part where the poor assembly occurs as described above at the cutting of the band-shaped preliminary assembly avoids wasteful assembling of the first catalyst layer with the part with the defect and the part where the poor assembly occurs. The facilitated MEGA manufacturing process ensures the improved productivity of the MEGA.

The assembly apparatus according to the one aspect may be configured such that, for example, the conveyance unit is configured to rotate one of the first rollers and another of the first rollers at different rotation speeds to match the inclination of the preliminary assembly with the inclination of the first catalyst layer, and the pair of second rollers are turnably disposed around a turning axis to adjust inclinations with respect to the conveying direction.

With this configuration, the conveyance unit can rotate the one first roller and the other first roller at the different rotation speeds to match the inclination of the preliminary assembly with the inclination of the first catalyst layer. Furthermore, the conveyance unit can rotate the pair of first rollers at the same rotation speed to insert the preliminary assembly between the pair of transfer rollers. This ensures assembling the first catalyst layer with the preliminary assembly in the state where the positional displacement between the first catalyst layer and the preliminary assembly is reduced.

In the adjustment of the inclination of the preliminary assembly, the pair of second rollers turn around the turning axis for adjusting the inclination with respect to the conveying direction of the band-shaped sheet, and the inclination with respect to the conveying direction varies with the preliminary assembly. This avoids occurrence of twist on the preliminary assembly including the ultra thin electrolyte membrane, and the occurrence of the failure such as separation on the preliminary assembly can be suppressed.

Another aspect of this disclosure is a method for manufacturing an electrolyte membrane-electrode-gas diffusion layer-assembly where a first catalyst layer and a preliminary assembly are assembled. The method includes: detecting an inclination of the first catalyst layer with respect to a conveying direction of a band-shaped sheet while conveying the band-shaped sheet on which a plurality of the first catalyst layers are formed; detecting an inclination of the preliminary assembly with respect to the conveying direction; adjusting the inclination of the preliminary assembly such that the inclination of the preliminary assembly matches the inclination of the first catalyst layer, and inserting the preliminary assembly between a pair of transfer rollers; and transferring the first catalyst layer from the band-shaped sheet to the preliminary assembly between the pair of transfer rollers. The adjusting includes: using a pair of first rollers and a pair of second rollers to convey the preliminary assembly, the pair of first rollers being arranged to be separated in a width direction of the preliminary assembly, the width direction intersecting with the conveying direction, the pair of first rollers rotating in contact with the preliminary assembly, the pair of second rollers being arranged to be separated in the width direction of the preliminary assembly, the pair of second rollers rotating while the pair of second rollers sandwiches the preliminary assembly with the pair of first rollers; and turning at least one of the first roller or the second roller with the preliminary assembly around a turning axis perpendicular to the conveying direction to adjust the inclination of the preliminary assembly.

With this aspect, in the adjusting, the occurrence of twist on the preliminary assembly including the ultra thin electrolyte membrane is avoided, and the occurrence of the failure such as separation on the preliminary assembly can be suppressed. Matching the inclination of the preliminary assembly with the inclination of the first catalyst layer in the adjusting ensures assembling the first catalyst layer with the preliminary assembly in the state where the positional displacement between the first catalyst layer and the preliminary assembly is reduced in the transferring even when the first catalyst layer has the inclination with respect to the conveying direction of the band-shaped sheet. Accordingly, the first catalyst layer and the second catalyst layer of the MEGA can be surely disposed at the opening of the resin sheet, thus ensuring the improved power generation efficiency of the cell for fuel cell.

The above-described aspects of this disclosure can provide an assembly apparatus and a manufacturing method for a membrane-electrode-gas diffusion layer-assembly for a cell for fuel cell capable of positioning and assembling materials while suppressing a failure caused in the above-described conventional carrying apparatus.

### BRIEF DESCRIPTION OF THE DRAWINGS

FIG. 1 is a schematic exploded view describing a configuration of a cell for fuel cell;

FIG. 2 is a schematic enlarged cross-sectional view of an assembly (MEGA);

FIG. 3 is a plan view illustrating a state where a first catalyst layer and a preliminary assembly illustrated in FIG. 2 are assembled;

FIG. 4 is a perspective view schematically illustrating an assembly apparatus according to an embodiment of the disclosure;

FIG. 5 is a perspective view schematically illustrating a main part of the assembly apparatus illustrated in FIG. 4;

FIG. 6 is a perspective view schematically illustrating a conveyance unit illustrated in FIG. 5;

FIG. 7 is a side view schematically illustrating the conveyance unit illustrated in FIG. 5;

FIG. 8 is a schematic diagram of a manufacturing apparatus for the preliminary assembly constituting the assembly illustrated in FIG. 2;

FIG. 9 is a flowchart illustrating an exemplary manufacturing method for the preliminary assembly by the manufacturing apparatus illustrated in FIG. 8;

FIG. 10 is a flowchart of the manufacturing method for the assembly of the embodiment by the assembly apparatus illustrated in FIG. 4;

FIG. 11 is a conceptual development diagram for describing each process of the manufacturing method illustrated in FIG. 10;

FIG. 12 is a schematic side view of a conveyance unit according to a modification of the assembly apparatus illustrated in FIG. 4; and

FIG. 13 is a schematic perspective view of the conveyance unit illustrated in FIG. 12.

### DETAILED DESCRIPTION

The following describes an assembly apparatus of materials of an electrolyte membrane-electrode-gas diffusion layer-assembly for a fuel cell and a manufacturing method according to this disclosure with reference to the drawings.

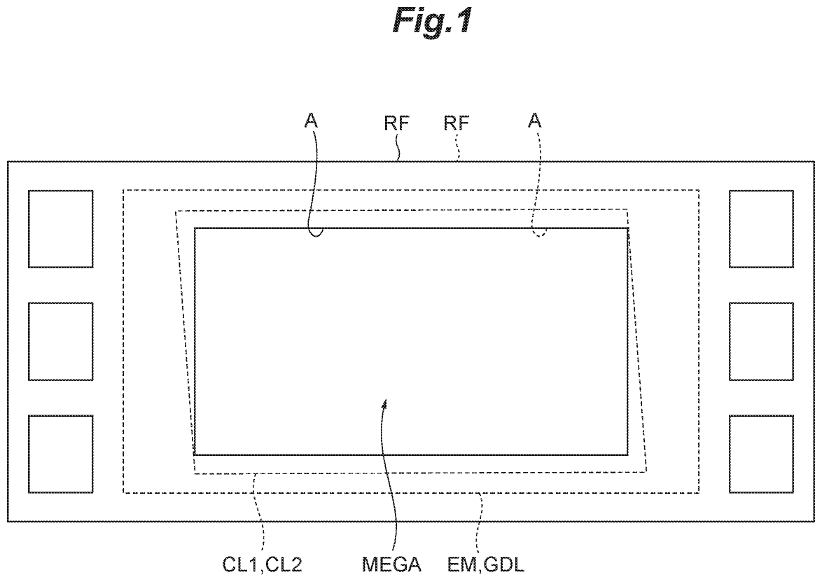

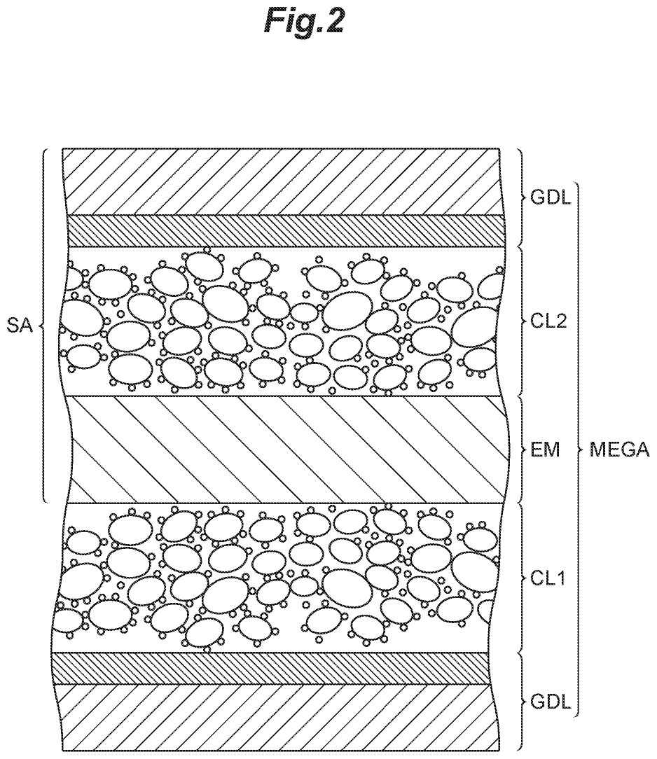

FIG. 1 is a schematic exploded view describing an exemplary configuration of a cell for fuel cell. FIG. 2 is a schematic enlarged cross-sectional view of the electrolyte membrane-electrode-gas diffusion layer-assembly (hereinafter referred to as an “assembly (MEGA)” for short in some cases) constituting the fuel cell. In FIG. 1, a pair of separators are not illustrated.

The cell for fuel cell includes, for example, a pair of separators, a pair of frame-shaped resin frames RF disposed between the pair of separators, and an assembly (MEGA) disposed between the pair of resin frames RF. The cell for fuel cell performs electric generation such that a gas containing oxygen and a gas containing hydrogen are flown through gas flow channels between the pair of separators and the assembly (MEGA), and these gases are reacted via the assembly (MEGA).

The assembly (MEGA) has a configuration where, for example, a gas diffusion layer GDL, a first catalyst layer CL1, an electrolyte membrane EM, a second catalyst layer CL2, and a gas diffusion layer GDL are laminated in this order and assembled. The assembly (MEGA) is disposed at a position where the first catalyst layer CL1 and the second catalyst layer CL2 correspond to openings A of the pair of resin frames RF. While it is not especially limited, the first catalyst layer CL1 is, for example, a cathode catalyst layer and the second catalyst layer CL2 is, for example, an anode catalyst layer.

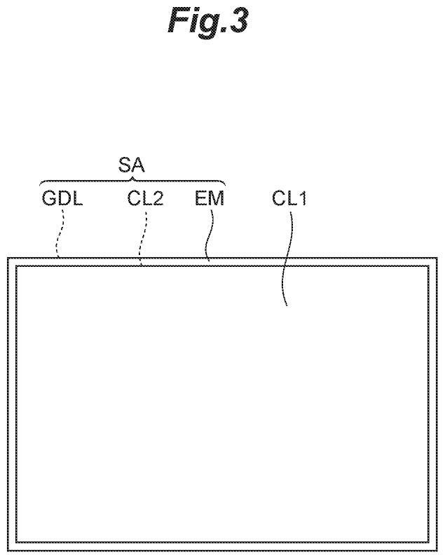

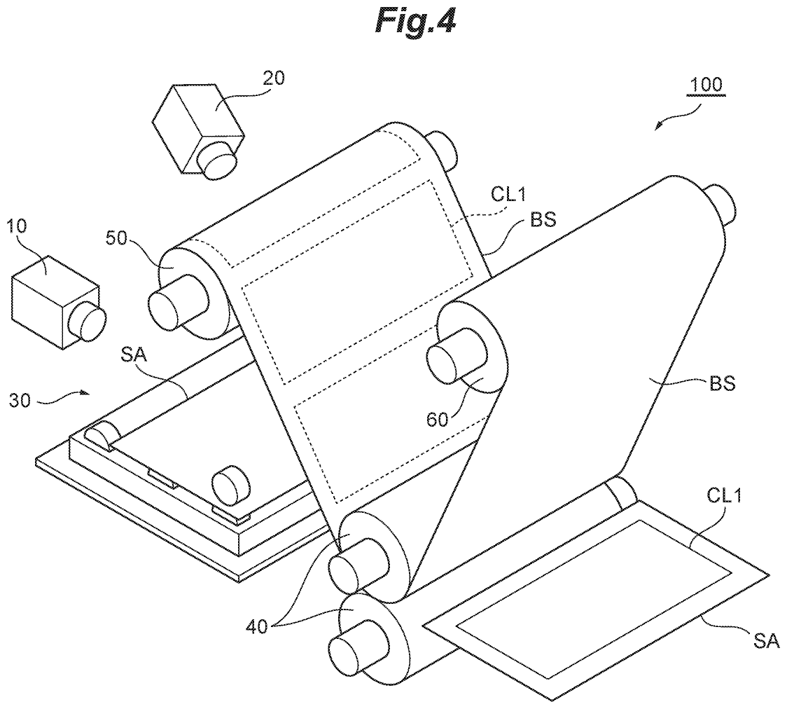

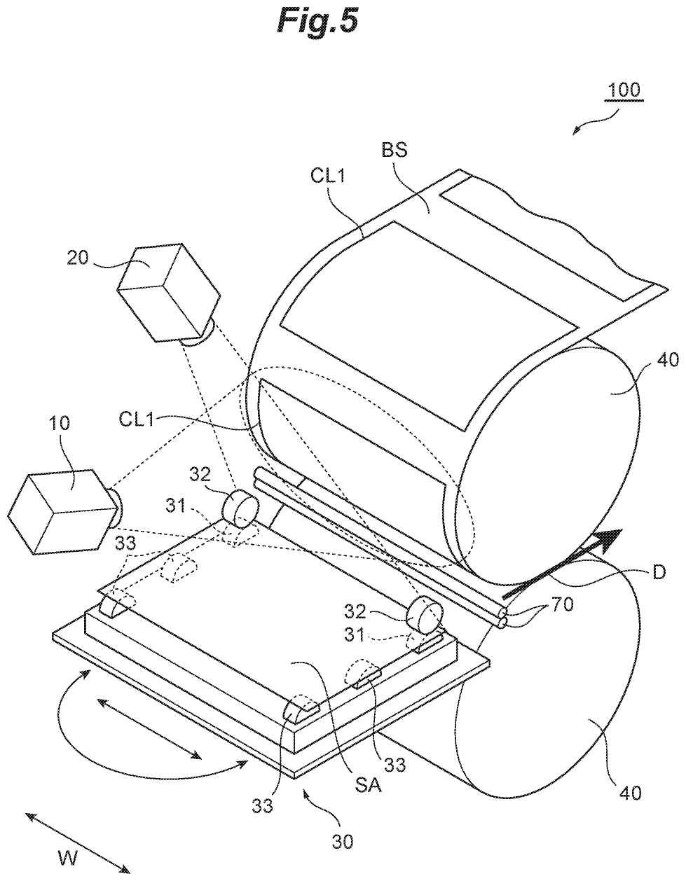

FIG. 3 is a plan view illustrating the state where the first catalyst layer CL1 and the preliminary assembly SA as materials of the assembly (MEGA) illustrated in FIG. 2 are assembled. FIG. 4 is a perspective view schematically illustrating an assembly apparatus 100 according to the embodiment. FIG. 5 is a perspective view schematically illustrating the main part of the assembly apparatus 100 illustrated in FIG. 4. While the details will be described later, the assembly apparatus 100 of the embodiment is mainly characterized by the following configuration.

The assembly apparatus 100 of this embodiment is an apparatus that assembles the first catalyst layer CL1 and the preliminary assembly SA constituting the electrolyte membrane-electrode-gas diffusion layer-assembly (MEGA). The assembly apparatus 100 includes a pair of transfer rollers 40, a first detection unit 10, a second detection unit 20, and a conveyance unit 30. The pair of transfer rollers 40 transfer the first catalyst layer CL1 from a band-shaped sheet BS to the preliminary assembly SA while conveying the band-shaped sheet BS on which a plurality of the first catalyst layers CL1 are formed. The first detection unit 10 detects an inclination of the first catalyst layer CL1 with respect to a conveying direction D of the band-shaped sheet BS. The second detection unit 20 detects an inclination of the preliminary assembly SA with respect to the conveying direction D of the band-shaped sheet BS.

The conveyance unit 30 is disposed to be capable of adjusting the inclination of the preliminary assembly SA such that the inclination of the preliminary assembly SA matches the inclination of the first catalyst layer CL1, and configured to insert the preliminary assembly SA between the pair of transfer rollers 40. The conveyance unit 30 includes a pair of first rollers 31 and a pair of second rollers 32. The pair of first rollers 31 are arranged to be separated in a width direction W of the band-shaped sheet BS intersecting with the conveying direction D, and rotate in contact with the preliminary assembly SA. The pair of second rollers 32 are arranged to be separated in the width direction W of the band-shaped sheet BS, and rotate while sandwiching the preliminary assembly SA with the pair of first rollers 31. At least one of the first rollers 31 or the second rollers 32 is configured to vary an inclination with respect to the conveying direction D together with the preliminary assembly SA.

The following describes the configuration of the assembly apparatus 100 of this embodiment in more detail. As described above, the assembly apparatus 100 of this embodiment is an apparatus that laminates and assembles the first catalyst layer CL1 on the preliminary assembly SA as the material of the assembly (MEGA). The preliminary assembly SA and the first catalyst layer CL1 are formed in, for example, rectangular shapes. The assembly apparatus 100 of this embodiment includes, for example, a supply roller 50 that supplies the band-shaped sheet BS, a collection roller 60 that collects the band-shaped sheet BS, and a pair of guide rollers 70 that guide the preliminary assembly SA, in addition to the above-described first detection unit 10, second detection unit 20, conveyance unit 30, and transfer roller 40.

For example, the band-shaped sheet BS is wound around the supply roller 50, and the supply roller 50 supplies the band-shaped sheet BS between the pair of transfer rollers 40. The band-shaped sheet BS wound around the supply roller 50 is a back sheet that supports and conveys the first catalyst layer CL1 to laminate the first catalyst layer CL1 on the preliminary assembly SA. The band-shaped sheet BS has one surface where a plurality of first catalyst layers CL1 are formed in the longitudinal direction of the band-shaped sheet BS, that is, the conveying direction D at predetermined intervals.

The pair of transfer rollers 40 transfer the first catalyst layer CL1 from the band-shaped sheet BS to the preliminary assembly SA while conveying the band-shaped sheet BS where the plurality of first catalyst layers CL1 are formed. More specifically, the pair of transfer rollers 40 are disposed, for example, to be adjacent in the up-down direction so as to have the rotation axes approximately horizontal. The pair of transfer rollers 40 are configured to rotate in mutually opposite directions, and sandwich the band-shaped sheet BS to convey. The pair of transfer rollers 40 sandwich the preliminary assembly SA inserted therebetween by the conveyance unit 30 with the band-shaped sheet BS, and transfer the first catalyst layer CL1 formed on the band-shaped sheet BS to the electrolyte membrane EM of the preliminary assembly SA by applying pressure and assembling.

In this embodiment, the conveying direction D of the band-shaped sheet BS is, for example, a tangential direction of a lower end of one transfer roller 40 disposed on the upper side and an upper end of the other transfer roller 40 disposed on the lower side. For ease of description, hereinafter, the conveying direction D of the band-shaped sheet BS is simply referred to as the “conveying direction D,” and the width direction W of the band-shaped sheet BS perpendicular to this conveying direction D is simply referred to as the “width direction W,” in some cases.

For example, the collection roller 60 winds and collects the band-shaped sheet BS after the transfer of the first catalyst layer CL1 to the preliminary assembly SA by the transfer roller 40. That is, the band-shaped sheet BS having the one surface where the plurality of first catalyst layers CL1 are formed is conveyed from the supply roller 50 between the pair of transfer rollers 40, applied with pressure by the transfer rollers 40 to transfer the first catalyst layer CL1 to the preliminary assembly SA, and subsequently, wound up and collected by the collection roller 60.

The first detection unit 10 detects the inclination of the first catalyst layer CL1 with respect to the conveying direction D. In the assembly apparatus 100 of this embodiment, for example, the first detection unit 10 is an imaging device that takes an image of the individual first catalyst layer CL1 formed on the band-shaped sheet BS. The first detection unit 10 detects the center line along the conveying direction D and the center line along the width direction W of the first catalyst layer CL1 to detect the inclination and the position of the first catalyst layer CL1. More specifically, for example, the first detection unit 10 detects the position of the first catalyst layer CL1 in the width direction W of the band-shaped sheet BS. The first detection unit 10 is not limited to the imaging device insofar as the inclination and the position of the first catalyst layer CL1 can be detected, and the first detection unit 10 may be, for example, a laser-type displacement sensor.

The second detection unit 20 detects the inclination of the preliminary assembly SA with respect to the conveying direction D. In the assembly apparatus 100 of this embodiment, for example, the second detection unit 20 is an imaging device that takes an image of the preliminary assembly SA located on the conveyance unit 30. The second detection unit 20 detects the center line along the conveying direction D and the center line along the width direction W of the preliminary assembly SA to detect the inclination and the position of the preliminary assembly SA. More specifically, for example, the second detection unit 20 detects the position of the preliminary assembly SA in the width direction W. The second detection unit 20 is not limited to the imaging device insofar as the inclination and the position of the preliminary assembly SA can be detected, and the second detection unit 20 may be, for example, a laser-type displacement sensor.

The conveyance unit 30 is disposed to be capable of adjusting the inclination of the preliminary assembly SA such that the inclination of the preliminary assembly SA matches the inclination of the first catalyst layer CL1, and configured to insert the preliminary assembly SA between the pair of transfer rollers 40. More specifically, the conveyance unit 30 includes the pair of first rollers 31 and the pair of second rollers 32. The pair of first rollers 31 are arranged to be separated in the width direction W of the band-shaped sheet BS intersecting with the conveying direction D, and rotate in contact with the preliminary assembly SA. The pair of second rollers 32 are arranged to be separated in the width direction W, and rotate while sandwiching the preliminary assembly SA with the pair of first rollers 31.

The pair of first rollers 31 are arranged, for example, below the preliminary assembly SA, and rotate in contact with a lower surface of the preliminary assembly SA. The pair of second rollers 32 are arranged, for example, above the preliminary assembly SA, and rotate in contact with a top surface of the preliminary assembly SA. In this embodiment, the conveyance unit 30 is arranged on a rear side in a conveying direction D1 of the preliminary assembly SA by the first rollers 31 and the second rollers 32, and the conveyance unit 30 includes a plurality of supporting rollers 33 that support the lower surface of the preliminary assembly SA.

The conveyance unit 30 drives to rotate at least one of the first rollers 31 or the second rollers 32 with a drive unit such as a motor. Thus, the conveyance unit 30 can convey the preliminary assembly SA sandwiched between the pair of first rollers 31 and the pair of second rollers 32 in the conveying direction D1 along the conveying direction D of the band-shaped sheet BS, and insert the preliminary assembly SA between the pair of transfer rollers 40.

Furthermore, as described above, the assembly apparatus 100 is configured such that at least one of the first rollers 31 or the second rollers 32 is configured to vary the inclination with respect to the conveying direction D together with the preliminary assembly SA. The assembly apparatus 100 of this embodiment is configured such that both the first rollers 31 and the second rollers 32 are configured to vary the inclinations with respect to the conveying direction D together with the preliminary assembly SA.

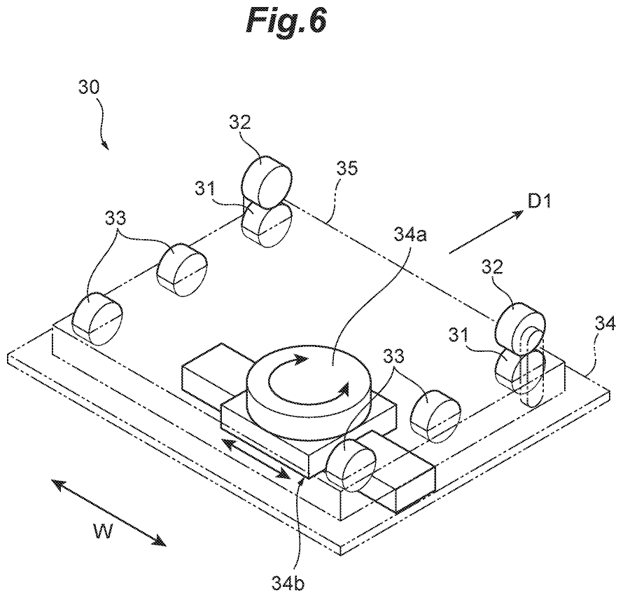

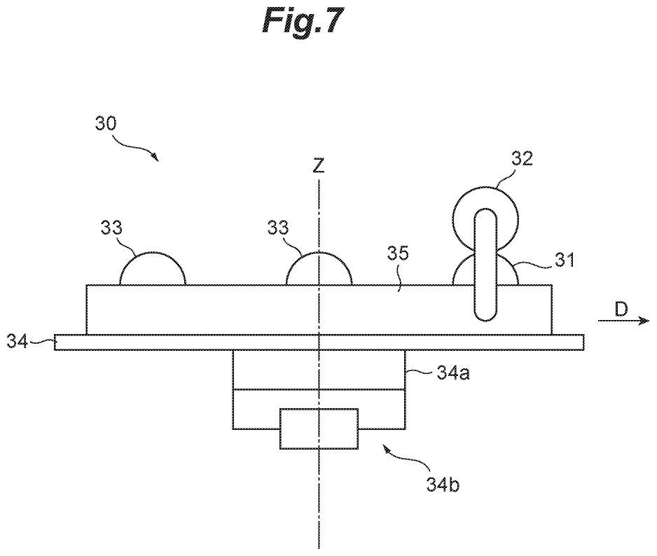

FIG. 6 and FIG. 7 are a perspective view and a side view, respectively, schematically illustrating the conveyance unit 30 illustrated in FIG. 5. FIG. 6 omits the illustrations of an adjustment table 34 and a frame portion 35 for clearly illustrating the configurations of respective components of the conveyance unit 30.

In the assembly apparatus 100 of this embodiment, the conveyance unit 30 includes, for example, the adjustment table 34 on which the preliminary assembly SA is placed. The first rollers 31 and the second rollers 32 are disposed on, for example, the adjustment table 34. The adjustment table 34 includes, for example, a rotating unit 34a that adjusts the inclination with respect to the conveying direction D to match the inclination of the preliminary assembly SA with the inclination of the first catalyst layer CL1.

More specifically, the adjustment table 34 includes the frame portion 35 that rotatably supports the first rollers 31, the second rollers 32 and the supporting rollers 33, and places the preliminary assembly SA on the first rollers 31 and the supporting rollers 33. The adjustment table 34 includes, for example, a rotating unit 34a that adjusts the inclination with respect to the conveying direction D to match the inclination of the preliminary assembly SA with the inclination of the first catalyst layer CL1. The rotating unit 34a includes, for example, a motor and a decelerator, and rotates the adjustment table 34 around a Z-axis perpendicular to the conveying direction D and the width direction W.

The adjustment table 34 includes a drive unit 34b capable of adjusting the position in the width direction W. The drive unit 34b adjusts the position of the adjustment table 34 in the width direction W to match the position of the preliminary assembly SA with the position of the first catalyst layer CL1. The drive unit 34b includes, for example, a linear motor, and moves the adjustment table 34 along the width direction W.

The pair of guide rollers 70 are arranged on, for example, upper and lower sides of the preliminary assembly SA conveyed and inserted between the pair of transfer rollers 40 by the conveyance unit 30 so as to sandwich the preliminary assembly SA. The pair of guide rollers 70 rotate around a rotation axis parallel to the width direction W, thus guiding the preliminary assembly SA in the conveying direction D to insert between the pair of transfer rollers 40.

In this embodiment, the preliminary assembly SA as the material of the assembly (MEGA) is the assembly of, for example, the electrolyte membrane EM, the second catalyst layer CL2, and the gas diffusion layer GDL as illustrated in FIG. 2. The preliminary assembly SA can be manufactured with, for example, the following manufacturing method.

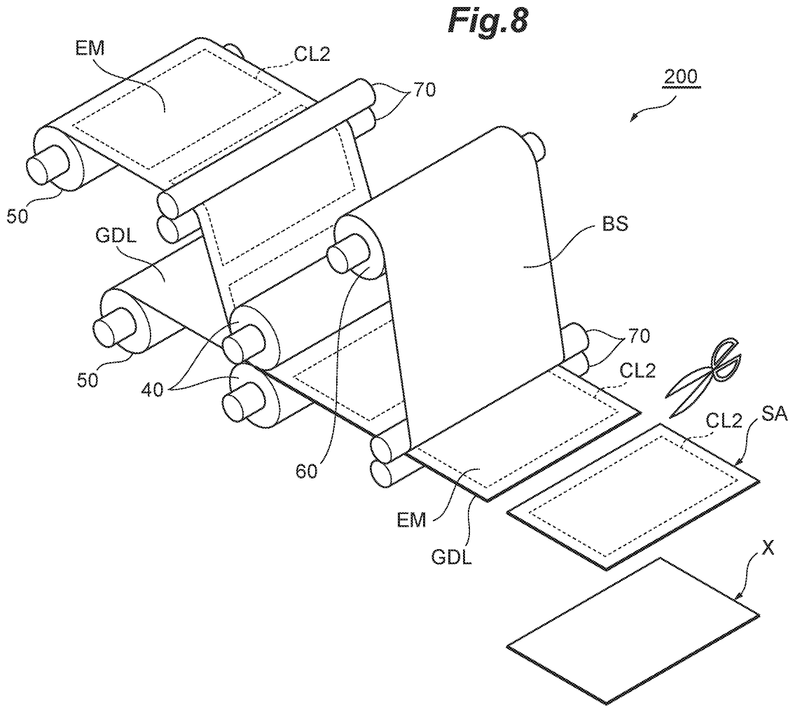

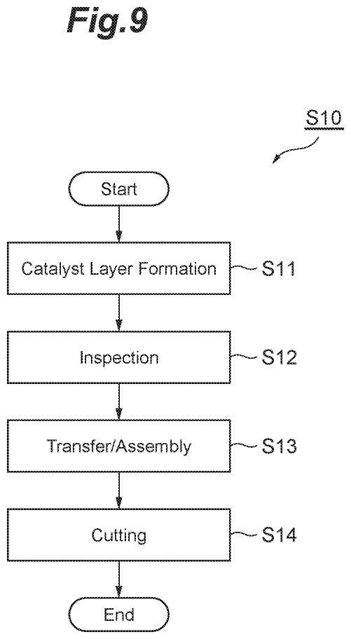

FIG. 8 is a schematic diagram of a manufacturing apparatus 200 for the preliminary assembly SA constituting the assembly (MEGA) illustrated in FIG. 2. FIG. 9 is a flowchart illustrating an exemplary manufacturing method S10 for the preliminary assembly SA by the manufacturing apparatus 200 illustrated in FIG. 8. In the manufacturing apparatus 200, components similar to those of the assembly apparatus 100 illustrated in FIG. 4 and FIG. 5 are attached by reference numerals identical to those of the assembly apparatus 100, and its description is omitted as appropriately.

The manufacturing method S10 for the preliminary assembly SA includes, for example, a catalyst layer formation process S11, an inspection process S12, a transfer/assembly process S13, and a cutting process S14.

In the catalyst layer formation process S11, for example, a slurry material of the second catalyst layer CL2 is intermittently applied over the ultra thin band-shaped electrolyte membrane EM supported by the band-shaped sheet BS as the back sheet. Thus, a plurality of rectangular second catalyst layers CL2 are formed in the conveying direction as the longitudinal direction of the band-shaped sheet BS at the predetermined intervals.

The inspection of the defect of the electrolyte membrane EM may be performed before the catalyst layer formation process S11, or before the formation of the second catalyst layer CL2 on the electrolyte membrane EM in the catalyst layer formation process S11. In this case, in the catalyst layer formation process S11, the second catalyst layer CL2 can be formed excluding the part where the defect of the electrolyte membrane EM has been detected, thus ensuring improved yield of the assembly (MEGA).

In the inspection process S12, the defect of the second catalyst layer CL2 formed on the band-shaped electrolyte membrane EM is inspected. In the inspection process S12, the defect of the band-shaped gas diffusion layer GDL supplied from the supply roller 50 is also inspected. When the defect is found in the inspection process S12, a flag indicating the fact is attached to the part with the defect.

In the transfer/assembly process S13, the band-shaped gas diffusion layer GDL is inserted between the pair of transfer rollers 40 with the band-shaped electrolyte membrane EM, on which the second catalyst layer CL2 is formed, supported by the band-shaped sheet BS. Thus, the band-shaped gas diffusion layer GDL is laminated on and assembled with the band-shaped electrolyte membrane EM on which a plurality of second catalyst layers CL2 are formed. Subsequently, the electrolyte membrane EM is peeled from the band-shaped sheet BS, and the band-shaped sheet BS is wound up by the collection roller 60 to be collected.

In the cutting process S14, the band-shaped preliminary assembly SA where the band-shaped electrolyte membrane EM, the plurality of second catalyst layers CL2, and the band-shaped gas diffusion layer GDL are assembled is cut between the individual second catalyst layers CL2. In the cutting process S14, an inspection may be performed for poor assembly of the band-shaped preliminary assembly SA before the cutting. In the cutting process S14, a defective product X with the defect of the preliminary assembly SA is disposed or used again as a resource. As described above, the rectangular preliminary assembly SA can be manufactured.

Thus, preliminarily assembling the electrolyte membrane EM, the second catalyst layer CL2, and the gas diffusion layer GDL and then cutting ensures the improved yield of the assembly (MEGA). That is, the part with the defect and the part with the poor assembly of the band-shaped electrolyte membrane EM, the second catalyst layer CL2, and the band-shaped gas diffusion layer GDL can be selectively removed in the cutting of the band-shaped preliminary assembly SA.

This avoids assembling the first catalyst layer CL1 with the part with the defect and the part with the poor assembly of the preliminary assembly SA, thus improving the yield of the assembly (MEGA). The manufacturing method S10 for the preliminary assembly SA of this embodiment facilitates the manufacturing process of the assembly (MEGA) compared with the conventional process, thus ensuring the improved productivity of the assembly (MEGA).

Next, the manufacturing method for the assembly (MEGA) using the assembly apparatus 100 of this embodiment will be described with the actions of the assembly apparatus 100 of this embodiment.

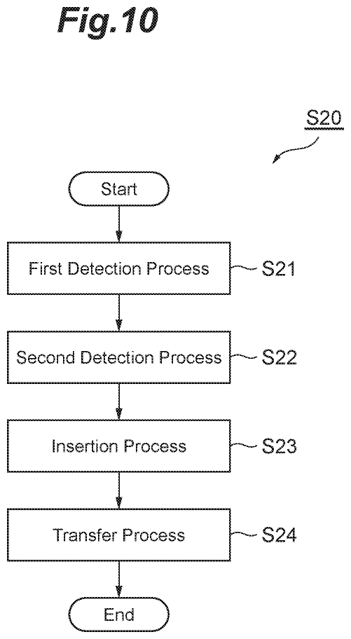

FIG. 10 is a flowchart of a manufacturing method S20 for the assembly (MEGA) of this embodiment using the assembly apparatus 100 illustrated in FIG. 4 to FIG. 7. The manufacturing method S20 for the assembly (MEGA) of this embodiment is the method for manufacturing the electrolyte membrane-electrode-gas diffusion layer-assembly where the first catalyst layer CL1 is assembled with the preliminary assembly SA. The manufacturing method S20 includes, for example, a first detection process S21, a second detection process S22, an insertion process S23, and a transfer process S24.

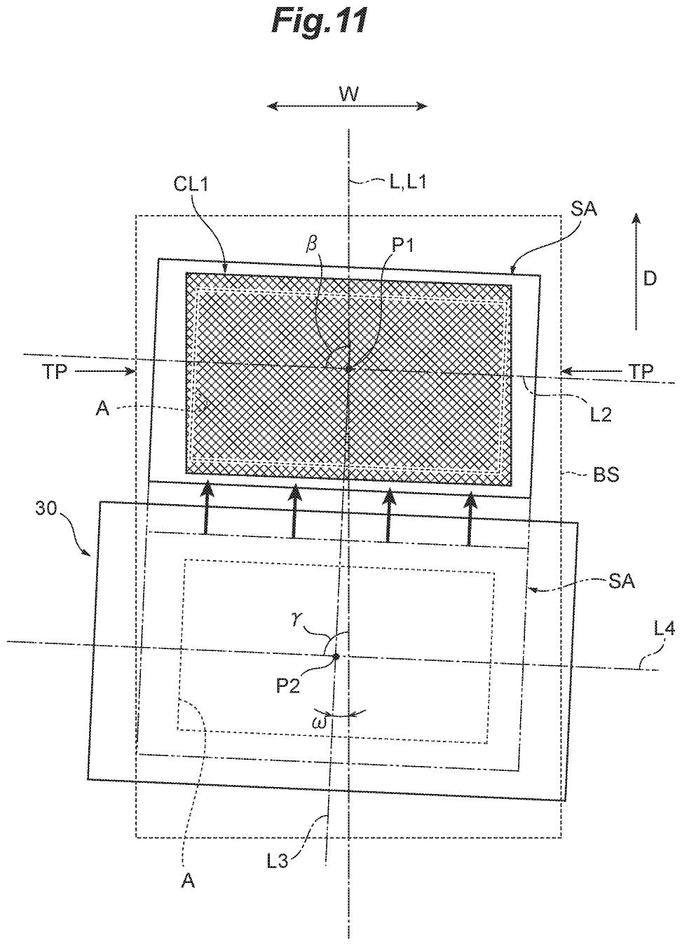

FIG. 11 is a conceptual development diagram for describing each process of the manufacturing method S20 illustrated in FIG. 10. In FIG. 11, the band-shaped sheet BS illustrated by dashed lines is deployed on a plane parallel to the conveying direction D and the width direction W of the band-shaped sheet BS between the pair of transfer rollers 40 illustrated in FIG. 5. FIG. 11 illustrates a state where the first catalyst layer CL1 is transferred from the band-shaped sheet BS to the preliminary assembly SA at a transfer position TP between the pair of transfer rollers 40.

The plurality of first catalyst layers CL1 are formed in the conveying direction D as the longitudinal direction of the band-shaped sheet BS at the predetermined intervals by, for example, intermittently applying a slurry material of the first catalyst layer CL1 over one surface of the band-shaped sheet BS. The first catalyst layer CL1 formed on the band-shaped sheet BS slightly has the inclinations with respect to the conveying direction D of the band-shaped sheet BS, variations in shape, displacements in position in the conveying direction D and the width direction W of the band-shaped sheet BS, or the like.

The first detection process S21 is a process to detect an inclination β of the first catalyst layer CL1 with respect to the conveying direction D of the band-shaped sheet BS while the band-shaped sheet BS, on which the plurality of first catalyst layers CL1 are formed, is conveyed. The first detection unit 10 obtains image data of the individual first catalyst layer CL1 on a rear side in the conveying direction D of the band-shaped sheet BS with respect to the transfer position TP between the pair of transfer rollers 40. The first detection unit 10 detects an outer peripheral edge of the individual first catalyst layer CL1 based on the obtained image data to detect four sides of the individual first catalyst layer CL1 having the rectangular outer shape.

The first detection unit 10 detects a longitudinal center line L1 along the conveying direction D of the band-shaped sheet BS and a lateral center line L2 along the width direction W of the band-shaped sheet BS of the individual first catalyst layer CL1 based on the detection result of the outer peripheral edge of the individual first catalyst layer CL1. In the example of FIG. 11, the longitudinal center line L1 of the first catalyst layer CL1 matches the center line L of the band-shaped sheet BS parallel to the conveying direction D. Meanwhile, the lateral center line L2 of the first catalyst layer CL1 is not parallel to the width direction W but inclined with respect to the conveying direction D with the inclination β less than 90°.

In this case, for example, the first detection unit 10 detects that an inclination α, which is not illustrated in FIG. 11, of the first catalyst layer CL1 with respect to the conveying direction D is 0°. For example, the first detection unit 10 detects that the inclination β of the lateral center line L2 of the first catalyst layer CL1 with respect to the conveying direction D parallel to the center line L of the band-shaped sheet BS is a certain angle less than 90°. The first detection unit 10 may detect an inclination of the lateral center line L2 of the first catalyst layer CL1 with respect to the width direction W of the band-shaped sheet BS.

For example, the first detection unit 10 detects a position of the center point of the first catalyst layer CL1, which is an intersection point of the center lines L1 and L2, as a position P1 of the individual first catalyst layer CL1 based on the detection result of the longitudinal center line L1 and the lateral center line L2 of the first catalyst layer CL1. For example, the first detection unit 10 detects the position P1 of the first catalyst layer CL1 in the width direction W of the band-shaped sheet BS. The first detection unit 10 may detect the position P1 of the first catalyst layer CL1 in the conveying direction D of the band-shaped sheet BS. In the example of FIG. 11, the first detection unit 10 detects that, for example, the position P1 of the first catalyst layer CL1 is positioned on the center line L in the width direction W and positioned on a certain coordinate in the conveying direction D.

The second detection process S22 is a process to detect an inclination γ of the preliminary assembly SA with respect to the conveying direction D. For example, the second detection unit 20 obtains image data of the individual preliminary assembly SA on the conveyance unit 30, and detects an outer peripheral edge of the individual preliminary assembly SA based on the obtained image data to detect four sides of the individual preliminary assembly SA having the rectangular outer shape. The second detection unit 20 detects a longitudinal center line L3 along the conveying direction D of the band-shaped sheet BS and a lateral center line L4 along the width direction W of the band-shaped sheet BS of the preliminary assembly SA located on the conveyance unit 30 based on the detection result of the outer peripheral edge of the preliminary assembly SA located on the conveyance unit 30.

Furthermore, for example, the second detection unit 20 detects inclinations ω and γ of the preliminary assembly SA with respect to the conveying direction D of the band-shaped sheet BS based on the detection results of the center lines L3 and L4. For example, the second detection unit 20 detects a position of the center point of the preliminary assembly SA, which is an intersection point of the center lines L3 and L4, as a position P2 of the preliminary assembly SA located on the conveyance unit 30 based on the detection results of the center lines L3 and L4. For example, the second detection unit 20 detects the position P2 of the preliminary assembly SA in the width direction W of the band-shaped sheet BS. The second detection unit 20 may detect the position P2 of the preliminary assembly SA in the conveying direction D of the band-shaped sheet BS.

In the insertion process S23, for example, the inclination γ of the preliminary assembly SA is adjusted such that the inclination γ of the lateral center line L4 of the preliminary assembly SA with respect to the conveying direction D matches the inclination of the lateral center line L2 of the first catalyst layer CL1 with respect to the conveying direction D, and the preliminary assembly SA is inserted between the pair of transfer rollers 40. The inclination ω of the preliminary assembly SA may be adjusted such that the inclination ω of the longitudinal center line L3 of the preliminary assembly SA with respect to the conveying direction D matches the inclination α, which is not illustrated in FIG. 11, of the longitudinal center line L1 of the first catalyst layer CL1 with respect to the conveying direction D, thus inserting the preliminary assembly SA between the pair of transfer rollers 40.

In the insertion process S23, the conveyance unit 30 may insert the preliminary assembly SA between the pair of transfer rollers 40 with the inclinations ω and γ of the preliminary assembly SA adjusted as follows. For example, the conveyance unit 30 adjusts the inclinations ω and γ and the position P2 of the preliminary assembly SA based on the detection results by the first detection unit 10 and the second detection unit 20 such that differences between the inclinations ω and γ of the preliminary assembly SA and the inclinations α and β of the first catalyst layer CL1 at the transfer position TP, and a difference between the position P1 of the first catalyst layer CL1 and the position P2 of the preliminary assembly SA each become minimum.

In the insertion process S23, the conveyance unit 30 may insert the preliminary assembly SA between the pair of transfer rollers 40 with the inclinations ω and γ of the preliminary assembly SA adjusted as follows. For example, the position of the opening A of the resin frame RF illustrated in FIG. 1 is virtually superimposed on the image of the preliminary assembly SA obtained by the second detection unit 20. Subsequently, the conveyance unit 30 adjusts the inclinations ω and γ and the position P2 of the preliminary assembly SA such that the opening A fits inside the outer edge of the first catalyst layer CL1, that is, fits in a region where the first catalyst layer CL1 is formed, at the transfer position TP.

The transfer process S24 is a process to transfer the first catalyst layer CL1 from the band-shaped sheet BS to the preliminary assembly SA between the pair of transfer rollers 40. Thus, as illustrated in FIG. 3, the assembly where the first catalyst layer CL1 and the preliminary assembly SA are assembled can be manufactured.

As described above, in the assembly apparatus 100 of this embodiment, the conveyance unit 30 is disposed to be capable of adjusting the inclination of the preliminary assembly SA such that the inclination of the preliminary assembly SA matches the inclination of the first catalyst layer CL1, and configured to insert the preliminary assembly SA between the pair of transfer rollers 40. The conveyance unit 30 includes the pair of first rollers 31 and the pair of second rollers 32. The first rollers 31 are arranged to be separated in the width direction W of the band-shaped sheet BS intersecting with the conveying direction D, and rotate in contact with the preliminary assembly SA. The second rollers 32 are arranged to be separated in the width direction W of the band-shaped sheet BS, and rotate while sandwiching the preliminary assembly SA with the pair of first rollers 31. The first rollers 31 and the second rollers 32 are configured to vary the inclinations with respect to the conveying direction D together with the preliminary assembly SA.

That is, in the manufacturing method S20 for the assembly (MEGA) of this embodiment, in the insertion process S23, the pair of first rollers 31, which are arranged to be separated in the width direction of the preliminary assembly SA intersecting with the conveying direction D and rotate in contact with the preliminary assembly SA, and the pair of second rollers 32, which are arranged to be separated in the width direction of the preliminary assembly SA and rotate while sandwiching the preliminary assembly SA with the pair of first rollers 31, are used to convey the preliminary assembly SA. Subsequently, at least one of the first roller 31 or the second roller 32, both in this embodiment, are turned with the preliminary assembly SA around the turning axis Z perpendicular to the conveying direction D to adjust the inclinations ω and γ of the preliminary assembly SA.

Accordingly, for example, when the conveyance unit 30 rotates the preliminary assembly SA to adjust the inclination γ such that the inclination γ of the preliminary assembly SA matches the inclination β of the first catalyst layer CL1, the first rollers 31 and the second rollers 32 turn with the preliminary assembly SA. The inclinations of the first rollers 31 and the second rollers 32 with respect to the conveying direction D vary in accordance with the inclination γ of the preliminary assembly SA. Thus, the occurrence of twist on the preliminary assembly SA including the ultra thin electrolyte membrane EM is avoided, and the occurrence of the failure such as separation on the preliminary assembly SA can be suppressed.

Matching the inclination γ of the preliminary assembly SA with the inclination β of the first catalyst layer CL1 ensures assembling the first catalyst layer CL1 with the preliminary assembly SA in the state where the positional displacement between the first catalyst layer CL1 and the preliminary assembly SA is reduced even when the first catalyst layer CL1 has the inclination β with respect to the conveying direction of the band-shaped sheet BS. Accordingly, the first catalyst layer CL1 and the second catalyst layer CL2 of the assembly (MEGA) can be surely disposed at the opening A of the resin frame RF, thus ensuring the improved power generation efficiency of the cell for fuel cell.

As described above, in the assembly apparatus 100 of this embodiment, the conveyance unit 30 includes, for example, the adjustment table 34 on which the preliminary assembly SA is placed. The first rollers 31 and the second rollers 32 are disposed on the adjustment table 34. The adjustment table 34 includes the rotating unit 34a that adjusts the inclination with respect to the conveying direction D to match the inclination γ of the preliminary assembly SA with the inclination β of the first catalyst layer CL1.

With this configuration, the preliminary assembly SA is placed on the adjustment table 34 and the adjustment table 34 is rotated by the rotating unit 34a, thus ensuring the adjustment of the inclination of the adjustment table 34 with respect to the conveying direction D of the band-shaped sheet BS. Accordingly, the inclination γ of the preliminary assembly SA can be matched with the inclination β of the first catalyst layer CL1. Furthermore, the adjustment table 34 includes the first rollers 31 and the second rollers 32. Therefore, rotating the adjustment table 34 on which the preliminary assembly SA is place to adjust the inclination γ of the preliminary assembly SA with respect to the conveying direction D varies the inclinations of the first rollers 31 and the second rollers 32 with respect to the conveying direction D of the band-shaped sheet BS with the preliminary assembly SA. This avoids the occurrence of twist on the preliminary assembly SA including the ultra thin electrolyte membrane EM, and the occurrence of the failure such as separation on the preliminary assembly SA can be suppressed.

As described above, in the assembly apparatus 100 of this embodiment, the first detection unit 10 detects the position P1 of the first catalyst layer CL1 in the width direction W of the band-shaped sheet BS, and the second detection unit 20 detects the position P2 of the preliminary assembly SA in the width direction W. The adjustment table 34 includes the drive unit 34b capable of adjusting the position in the width direction W. The drive unit 34b can adjust the position in the width direction W of the adjustment table 34 to match the position P2 of the preliminary assembly SA with the position P1 of the first catalyst layer CL1.

With this configuration, the adjustment table 34 on which the preliminary assembly SA is placed is moved by the drive unit 34b in the width direction W of the band-shaped sheet BS while the position of the adjustment table 34 is adjusted, thus ensuring the adjustment of the position P2 of the preliminary assembly SA. Therefore, even when the first catalyst layer CL1 formed on the band-shaped sheet BS has the displacement in position in the width direction W of the band-shaped sheet BS, the position P2 of the preliminary assembly SA can be matched with the position P1 of the first catalyst layer CL1. This ensures assembling the first catalyst layer CL1 with the preliminary assembly SA in the state where the positional displacement between the first catalyst layer CL1 and the preliminary assembly SA is reduced. Accordingly, the first catalyst layer CL1 and the second catalyst layer CL2 of the assembly (MEGA) can be surely disposed at the opening A of the resin frame RF, thus ensuring the improved power generation efficiency of the cell for fuel cell.

As described above, in the assembly apparatus 100 of this embodiment, the first detection unit 10 is configured, for example, to detect the inclinations α and β and the position P1 by detecting the center line L1 along the conveying direction D and the center line L2 along the width direction W of the first catalyst layer CL1. The second detection unit 20 is configured, for example, to detect the inclinations γ and ω and the position P2 by detecting the center line L3 along the conveying direction D and the center line L4 along the width direction W of the preliminary assembly SA.

With this configuration, for example, even when the first catalyst layer CL1 formed on the band-shaped sheet BS has the variation in shape, the positions of the preliminary assembly SA and the first catalyst layer CL1 can be matched by matching the positions P1 and P2 of the first catalyst layer CL1 and the preliminary assembly SA and by minimizing the difference |α−ω| between the inclinations of the longitudinal center lines L1 and L3 and the difference |β−γ| between the inclinations of the lateral center lines L2 and L4. This ensures assembling the first catalyst layer CL1 with the preliminary assembly SA in the state where the positional displacement between the first catalyst layer CL1 and the preliminary assembly SA is reduced. Accordingly, the first catalyst layer CL1 and the preliminary assembly SA of the assembly (MEGA) can be surely disposed at the opening A of the resin frame RF, thus ensuring the improved power generation efficiency of the cell for fuel cell.

In the assembly apparatus 100 of this embodiment, the first detection unit 10 and the second detection unit 20 are, for example, the imaging devices. With this configuration, as described above, the center lines L1 and L3 along the conveying direction D and the center lines L2 and L4 along the width direction W of the first catalyst layer CL1 and the preliminary assembly SA can be easily detected.

As described above, this embodiment can provide the assembly apparatus 100 and the manufacturing method S20 for the membrane-electrode-gas diffusion layer-assembly (MEGA) for the cell for fuel cell capable of positioning and assembling the materials while suppressing the failure caused in the conventional carrying apparatus. The assembly apparatus according to this disclosure is not limited to the configuration of the above-described assembly apparatus 100. The following describes a modification of the above-described assembly apparatus 100.

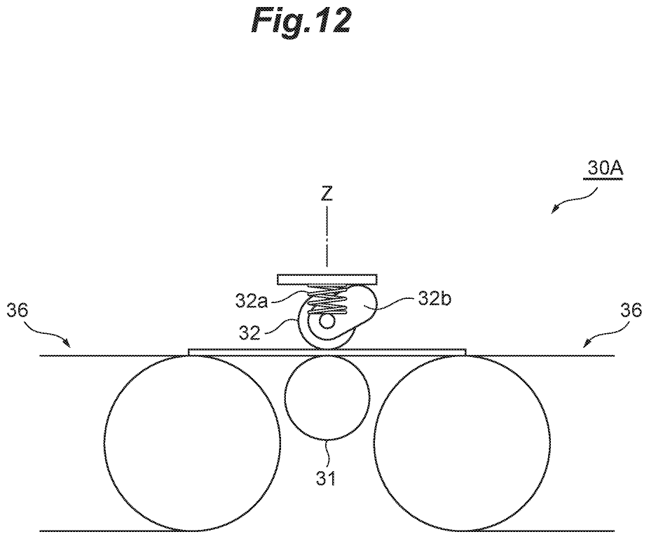

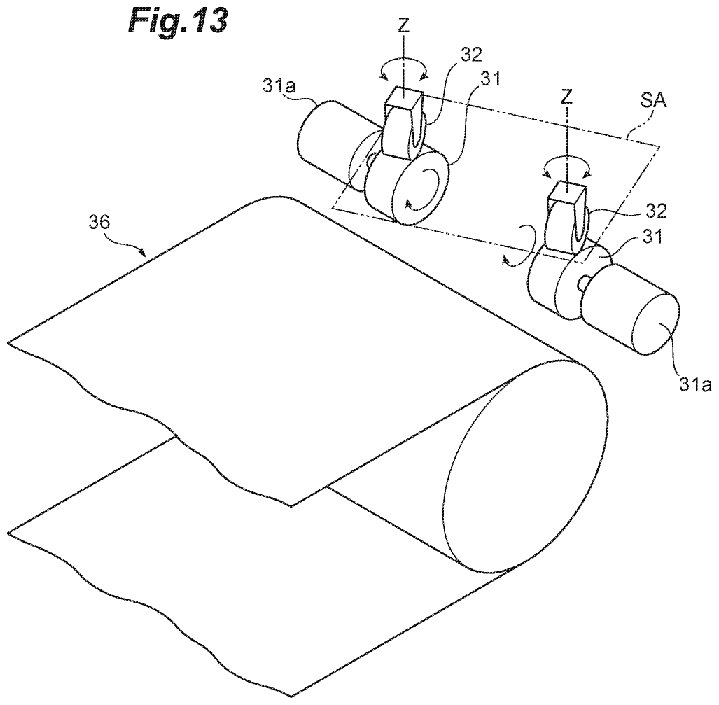

FIG. 12 is a schematic side view of a conveyance unit 30A according to the modification of the assembly apparatus 100 of the above-described embodiment. FIG. 13 is a schematic perspective view of the conveyance unit 30A according to the modification illustrated in FIG. 12.

In the assembly apparatus according to this modification, the conveyance unit 30A includes, for example, a conveyance conveyor 36, a pair of first rollers 31, and a pair of second rollers 32. The pair of first rollers 31, for example, each include a motor 31a, and the pair of first rollers 31 are rotatably disposed having different rotation speeds. The second rollers 32 include, for example, biasing members 32a and swivel casters 32b. The biasing member 32a includes, for example, a spring, and biases the second roller 32 toward the first roller 31. The swivel caster 32b turns the second roller 32 around a turning axis Z perpendicular to the conveying direction D and the width direction W.

In the assembly apparatus of this modification, the conveyance unit 30A is configured to rotate one first roller 31 and the other first roller 31 at different rotation speeds to match inclinations γ and ω of the preliminary assembly SA with inclinations α and β of the first catalyst layer CL1. The pair of second rollers 32 are tunably disposed around the turning axis Z to adjust the inclination with respect to the conveying direction D.

With this configuration, the conveyance unit 30 can rotate the one first roller 31 and the other first roller 31 at the different rotation speeds to match the inclinations γ and ω of the preliminary assembly SA with the inclinations α and β of the first catalyst layer CL1. Furthermore, the conveyance unit 30 can rotate the pair of first rollers 31 at the same rotation speed to convey the preliminary assembly SA on the conveyance conveyor 36, and can convey and insert the preliminary assembly SA between the pair of transfer rollers 40. This ensures assembling the first catalyst layer CL1 with the preliminary assembly SA in the state where the positional displacement between the first catalyst layer CL1 and the preliminary assembly SA is reduced.

In the adjustment of the inclinations γ and ω of the preliminary assembly SA, the pair of second rollers 32 turn around the turning axis Z for adjusting the inclination with respect to the conveying direction D of the band-shaped sheet BS, and the inclination with respect to the conveying direction D varies with the preliminary assembly SA. This avoids occurrence of twist on the preliminary assembly SA including the ultra thin electrolyte membrane EM, and the occurrence of the failure such as separation on the preliminary assembly SA can be suppressed.

Accordingly, this modification can also provide the assembly apparatus 100 and the manufacturing method S20 for the membrane-electrode-gas diffusion layer-assembly (MEGA) for the cell for fuel cell capable of positioning and assembling the materials while suppressing the failure caused in the conventional carrying apparatus.

While the embodiments of the assembly apparatus and the manufacturing method for the membrane-electrode-gas diffusion layer-assembly (MEGA) for the cell for fuel cell according to this disclosure have been described in detail with reference to the drawings, the specific configuration is not limited to the embodiments. Design changes and the like within a scope not departing from the gist of the present disclosure are included in this disclosure.

### DESCRIPTION OF SYMBOLS

10 First detection unit
20 Second detection unit
30 Conveyance unit
31 First roller
32 Second roller
34 Adjustment table
34a Rotating unit
34b Drive unit
40 Transfer roller
100 Assembly apparatus
BS Band-shaped sheet
CL1 First catalyst layer
CL2 Second catalyst layer
D Conveying direction
EM Electrolyte membrane
GL Gas diffusion layer
P1 Position
P2 Position
L1 Center line
L2 Center line
L3 Center line
L4 Center line
S20 Manufacturing method
S21 First detection process
S22 Second detection process
S23 Insertion process
S24 Transfer process
SA Preliminary assembly
MEGA Assembly (electrolyte membrane-electrode-gas diffusion layer-assembly)
W Width direction
Z Turning axis
β Inclination
γ Inclination
ω Inclination

What is claimed is:

1. An assembly apparatus that assembles a first catalyst layer and a preliminary assembly for constituting an electrolyte membrane-electrode-gas diffusion layer-assembly, the assembly apparatus comprising:
a pair of transfer rollers that transfer the first catalyst layer from a band-shaped sheet to the preliminary assembly while conveying the band-shaped sheet, a plurality of the first catalyst layers being formed on the band-shaped sheet;
a first detection unit that detects an inclination of the first catalyst layer with respect to a conveying direction of the band-shaped sheet;
a second detection unit that detects an inclination of the preliminary assembly with respect to the conveying direction; and
a conveyance unit disposed to be capable of adjusting the inclination of the preliminary assembly such that the inclination of the preliminary assembly matches the inclination of the first catalyst layer, the conveyance unit inserting the preliminary assembly between the pair of transfer rollers,
wherein the conveyance unit includes:
a pair of first rollers arranged to be separated in a width direction of the band-shaped sheet, the width direction intersecting with the conveying direction, the pair of first rollers rotating in contact with the preliminary assembly; and
a pair of second rollers arranged to be separated in the width direction, the pair of second rollers rotating while the pair of second rollers sandwiches the preliminary assembly with the pair of first rollers, and
wherein an inclination of at least one of the first roller or the second roller with respect to the conveying direction varies together with the preliminary assembly.

2. The assembly apparatus according to claim 1,
wherein the conveyance unit includes an adjustment table on which the preliminary assembly is placed,
wherein the first rollers and the second rollers are disposed on the adjustment table, and
wherein the adjustment table includes a rotating unit that adjusts the inclination with respect to the conveying direction to match the inclination of the preliminary assembly with the inclination of the first catalyst layer.

3. The assembly apparatus according to claim 2,
wherein the first detection unit detects a position of the first catalyst layer in the width direction of the band-shaped sheet,
wherein the second detection unit detects a position of the preliminary assembly in the width direction,
wherein the adjustment table includes a drive unit capable of adjusting a position in the width direction, and
wherein the drive unit adjusts the position of the adjustment table to match the position of the preliminary assembly with the position of the first catalyst layer.

4. The assembly apparatus according to claim 3,
wherein the first detection unit detects a center line along the conveying direction and a center line along the width direction of the first catalyst layer to detect the inclination and the position of the first catalyst layer, and
wherein the second detection unit detects a center line along the conveying direction and a center line along the width direction of the preliminary assembly to detect the inclination and the position of the preliminary assembly.

5. The assembly apparatus according to claim 4,
wherein the first detection unit and the second detection unit are imaging devices.

6. The assembly apparatus according to claim 1,
wherein the preliminary assembly is an assembly of an electrolyte membrane, a second catalyst layer, and a gas diffusion layer.

7. The assembly apparatus according to claim 1,
wherein the conveyance unit is configured to rotate one of the first rollers and another of the first rollers at different rotation speeds to match the inclination of the preliminary assembly with the inclination of the first catalyst layer, and
wherein the pair of second rollers are turnably disposed around a turning axis to adjust inclinations with respect to the conveying direction.

8. A method for manufacturing an electrolyte membrane-electrode-gas diffusion layer-assembly where a first catalyst layer and a preliminary assembly are assembled, the method comprising:
detecting an inclination of the first catalyst layer with respect to a conveying direction of a band-shaped sheet while conveying the band-shaped sheet on which a plurality of the first catalyst layers are formed;
detecting an inclination of the preliminary assembly with respect to the conveying direction;
adjusting the inclination of the preliminary assembly such that the inclination of the preliminary assembly matches the inclination of the first catalyst layer, and inserting the preliminary assembly between the pair of transfer rollers; and
transferring the first catalyst layer from the band-shaped sheet to the preliminary assembly between the pair of transfer rollers,
wherein the adjusting includes:
using a pair of first rollers and a pair of second rollers to convey the preliminary assembly, the pair of first rollers being arranged to be separated in a width direction of the preliminary assembly, the width direction intersecting with the conveying direction, the pair of first rollers rotating in contact with the preliminary assembly, the pair of second rollers being arranged to be separated in the width direction of the preliminary assembly, the pair of second rollers rotating while the pair of second rollers sandwiches the preliminary assembly with the pair of first rollers; and
turning at least one of the first roller or the second roller with the preliminary assembly around a turning axis perpendicular to the conveying direction to adjust the inclination of the preliminary assembly.
